(19) United States
(12) Patent Application Publication
(10) Pub. No.: US 2019/0211134 A1
(43) Pub. Date: Jul. 11, 2019

(54) THIOURETHANE POLYMERS, METHOD OF SYNTHESIS THEREOF AND USE IN FUSED FILAMENT FABRICATION PRINTING

(71) Applicants: Board of Regents, The University of Texas, Austin, TX (US); Adaptive 3D Technologies, Dallas, TX (US)

(72) Inventors: Gregory T. Ellson, Dallas, TX (US); Benjamin R. Lund, Wylie, TX (US); Walter Voit, Dallas, TX (US)

(21) Appl. No.: 16/323,941

(22) PCT Filed: Aug. 15, 2017
(86) PCT No.: PCT/US2017/046903

§ 371 Date: Feb. 7, 2019

Related U.S. Application Data
(60) Provisional application No. 62/377,231, filed on Aug. 19, 2016.

(51) Int. Cl. C08G 18/38; C08G 18/73; C08G 18/75; C08G 18/08; C09D 11/102; B33Y 70/00

(52) U.S. Cl. CPC C08G 18/3876; C08G 18/73; C08G 18/755; B29C 64/118; C09D 11/102; B33Y 70/00; C08G 18/0842

(57) ABSTRACT

A thermoplastic thiourethane polymer comprising a sequential chain of a first type of monomer covalently bonded to a second type of monomer via thiourethane linkages. The first type of monomer includes two or more thiol functional groups and the type of monomer includes two or more isocyanate functional groups. The first and second types of monomers are polymerized together in an anhydrous aprotic solvent-dissolved anionic step-growth polymerization reaction that is catalyzed by a non-nucleophillic base having a pKa greater than 7.

### CROSS-REFERENCES TO RELATED APPLICATION

This application claims the benefit under 35 U.S.C. § 119(e) of U.S. Provisional Patent Application No. 62/377,231 filed Aug. 19, 2016, which is incorporated herein by reference in its entirety as if fully set forth herein.

### TECHNICAL FIELD

This application is directed, in general, to thiourethane polymers and more specifically thermoplastic forms of such polymers, methods of synthesis, and, using such polymers in fused filament fabrication printing.

### BACKGROUND

Fused Filament Fabrication (FFF) printing is an increasingly accessible and low cost form of additive manufacturing technology for 3-dimensional (3D) polymer printing. Often, however, the thermoplastic polymers that are used for FFF printing are re-deployed from their originally intended common industrial application. Examples include polymers, such as acrylonitrile-butadiene-styrene (ABS), polylactic acid and polyurethanes, which are typically used in established large-scale production injection molding industrial applications. These re-deployed polymers, however, may not have desirable mechanical properties for FFF printing. For instance, these polymers can undergo substantial warping and curling during FFF printing. Moreover the final 3D printed polymer product can have poor mechanical performance when stressed perpendicular to the printed layer direction, due to mechanical anisotropy, resulting is poor adhesion between the printed layers. As such these polymer products are often limited to prototyping applications, jig setup uses, and not to structural end-use materials, e.g., polymer parts for high-performance industrial applications. Conversely, other polymers, which are suitable for end-use industrial applications, may not have a melting point that is low enough (e.g., 300° C.) to be used in commercially available FFF printers.

Thus, there is a continuing need to develop new thermoplastic polymers that are suitable for FFF printing manufacturing technologies.

### SUMMARY

The present disclosure provides in one embodiment, a thermoplastic thiourethane polymer. The polymer comprises a sequential chain of a first type of monomer covalently bonded to a second type of monomer via thiourethane linkages. The first type of monomer includes two or more thiol functional groups and the second type of monomer includes two or more isocyanate functional groups. The first and second types of monomers are polymerized together in an anhydrous aprotic solvent-dissolved anionic step-growth polymerization reaction that is catalyzed by a non-nucleophillic base having a pKa greater than 7.

In some embodiments the sequential chain can have the first type of monomer with aliphatic groups only. In some embodiments the sequential chain can have the second type of monomer with one or more aromatic, caged aliphatic, or cyclic aliphatic groups. In some embodiments, the sequential chain can have the second type of monomer with a linear aliphatic group.

In some embodiments, the polymer can have a toughness value of about 50 MJ/m³ or higher and the sequential chain includes the first type of monomer or the second type of monomer with a linear aliphatic group. In some embodiments, the first type of monomer can include a di-thiol functionalized monomer and a tri-thiol or higher functionalized monomer, wherein a mole percent of the first type of monomer having di-thiol functionalized monomers is in a range of from 25 to 100 percent and a mole percent of the first type of monomer having tri-thiol or higher functionalized monomers is in a range of from 75 to 0 to percent. In some embodiments, the second type of monomer can include a di-isocyanate functionalized monomer and a tri-isocyanate or higher functionalized monomer, wherein a mole percent of the second type of monomer having di-isocyanate functionalized monomers is in a range of from 25 to 100 percent and a mole percent of the second type of monomer having tri-isocyanate or higher functionalized monomers is in a range of from 75 to 0 to percent.

In some embodiments, the first type of monomer can include one or more of: Trimethylolpropane tris(3-mercaptopropionate); Trimethylolpropane tris(2-mercaptoacetate); Pentaerythritol tetrakis(2-mercaptoacetate); Pentaerythritol tetrakis(3-mercaptopropionate); 2,2′-(Ethylenedioxy)diethanethiol; 1,3-Propanedithiol; 1,2-Ethanedithiol; 1,4-butanedithiol; 1,5-pentanedithiol; 1,6-hexanedithiol; 1,9-nonanedithiol; xylene dithiol; Thiobis(benzenethiol); 1,4-Butanediol bis(thioglycolate); 1,4-bis(3-mercaptobutylyloxy)butane; Tris[2-(3-mercaptopropionyloxy)ethyl] isocyanurate; 3,4-ethylenedioxythiophene; 1,10-Decanedithiol; Tricyclo[5.2.1.02,6]decanedithiol; and Benzene-1,2-dithiol; Trithiocyanuric acid. In some embodiments, the second type of monomer can include one or more of: Hexamethylene diisocyanate; isophorone diisocyanate; diisocyanatobutane; diisocyanatooctane; 1,3,5-Tris(6-isocyanatohexyl)-1,3,5-triazinane-2,4,6-trione; phenylene diisocyanate; xylylene diisocyanate; tolyene diisocyanate; cyclohexylene diisocyanate; and toluene diisocyanate; methylenebis(phenyl isocyanate).

In some embodiments, the sequential chain can further include a third type of monomer with a single thiol functional group or a single isocyanate functional group, wherein a mole ratio of the single thiol functional group or the single isocyanate functional group of the third type of monomer relative to the two or more thiol functional groups or the two or more isocyanate functional groups of the first type of monomer or the second type of monomer, respectively, equals about 1:2 or less. In some such embodiments, the third type of monomer includes one or more of: 1-butanethiol; 1-hexanethiol; 1-heptanethiol; 1-octanethiol; 1-nonanethiol; 1-decanethiol; and 1-octadecanethiol, propyl isocyanate; 1-pentyl isocyanate; hexyl isocyanate; octyl isocyanate; nonyl isocyanate; sec-butyl isocyanate; 2-ethylhexyl isocyanate; cyclopentyl isocyanate; and 1-isocyanato-3-methylbutane.

Another embodiment of the disclosure is a method of synthesizing a thermoplastic thiourethane polymer. The method comprises forming a mixture that includes a first type of monomer and a second type of monomer dissolved in an anhydrous aprotic solvent. The method also comprises adding to the mixture a non-nucleophillic base catalyst having a pKa greater than 7 to thereby initiate an anionic step-growth polymerization reaction to form a sequential chain of the first type of monomer covalently bonded to the second type of monomer via thiourethane linkages, wherein, the first type of monomer includes two or more thiol functional groups and the second type of monomer includes two or more isocyanate functional groups.

In some embodiments, the anhydrous aprotic solvent can be a liquid from room temperature to about 70° C. and contains less than 0.2 weight percent water. In some embodiments, the anhydrous aprotic solvent can be a polar aprotic solvent. In some such embodiments, the polar aprotic solvent can include dimethylformamide (DMF), dimethylacetamide (DMA) and n-methyl-2-pyrrolidone (NMP); tetrahydrofuran; acetonitrile; dimethyl sulfoxide; nitromethane; and propylene carbonate or combinations thereof.

In some embodiments, the anionic step-growth polymerization reaction that is catalyzed by a non-nucleophillic base catalyst can be in an absence of a photo-initiated non-nucleophillic base catalyst. In some such embodiments, the non-nucleophillic base catalyst can include triethylamine, 1,8-Diazabicyclo[5.4.0]undec-7-ene, 1,5-Diazabicyclo[4.3.0]non-5-ene, Tributylamine, 4-(Dimethylamino)pyridine, 1,4-Diazabicyclo[2.2.2]octane, 1,1,3,3-Tetramethylguanidine, or combinations thereof.

In some embodiments, the non-nucleophillic base catalyst added to the solvent-based mixture can be less than about 0.1 wt % relative to the total weight of the first type of monomers plus the second type of monomers.

Still another embodiment of the disclosure is a method of fused filament fabrication printing. The method comprises leading a filament of a thermoplastic thiourethane polymer into an extruder of a fused filament fabrication printer. The thermoplastic thiourethane polymer includes a sequential chain of a first type of monomer covalently bonded to a second type of monomer via thiourethane linkages. The first type of monomer includes two or more thiol functional groups and the second type of monomer includes two or more isocyanate functional groups. The first and second types of monomers are polymerized together in an anhydrous aprotic solvent-dissolved anionic step-growth polymerization reaction that is catalyzed by a non-nucleophillic base having a pKa greater than 7. The method further comprises driving the filament through the extruder to a heated end of the extruder, to melt the thermoplastic thiourethane polymer and thereby extrude the thermoplastic thiourethane polymer to form a polymer part on a print bed of the printer.

### BRIEF DESCRIPTION OF DRAWINGS

For a more complete understanding of the present disclosure, reference is now made to the following detailed description taken in conjunction with the accompanying FIGUREs, in which:

FIG. 1 illustrates by flow diagram, selected aspects of an example method of synthesizing a thermoplastic thiourethane polymer according to the principles of the present disclosure;

FIG. 2 illustrates by flow diagram, a method of fused filament fabrication printing using the thermoplastic thiourethane polymers synthesized according to the principles of the present disclosure;

FIG. 3 presents selected aspects of a fused filament fabrication printer using filaments composed of the thiourethane polymers synthesized according to the principles of the present disclosure;

FIG. 4 presents example differential scanning calorimetry heating ramps of example thermoplastic thiourethane polymers synthesized according to the principles of the present disclosure and having monomer mole fractions as described in Table 1; and

FIG. 5 presents example tensile stress versus strain behavior at 20° C. for an example thermoplastic thiourethane polymer composition as described in the context of FIG. 4 and Table 1.

### DETAILED DESCRIPTION

Embodiments of the present disclosure benefit from the discovery that the synthesis of thermoplastic polymers according to the thiol-isocyanate click reaction disclosed herein can be tailored, through the choices of monomer reactants and reaction conditions, to produce polymers that overcome shortcomings of the different types of thermoplastics previously currently deployed for FFF printing.

The discovery of thiourethane thermoplastic polymers as a viable option for FFF printing was informed by our synthesis of a number of non-commercially available thermoplastic thiourethane polymers and characterization of their thermal and mechanical properties. As part of these experiments, we discovered that the thermoplastic thiourethane polymers of the disclosure has a surprisingly low water absorption and content, e.g., as compared to other polymers having functional groups such as urethane or amides that can form hydrogen bonds with water, e.g., about 2 wt % H₂O content or less in some embodiments. Such a low water content may be a desirable characteristic to have for polymers used in FFF printing applications, as this mitigates the volatilization of water at the heated end of the extruder of the FFF printer which may form vapor bubbles and cause foaming in the polymer. This in turn can decrease the interlayer interaction between printed layers layer and thereby increase mechanical anisotropy, and/or, can change the mechanical properties of the printed polymer product away from its desired properties.

Embodiments of the thermoplastic thiourethane polymers are synthesized in an anhydrous solvent-based anionic step-growth polymerization reaction. A solvent-dissolved reaction mixture includes a first type of monomer having two or more thiol functional groups and a second type of monomer having two or more isocyanate functional groups. An anionic step-growth polymerization mechanism is catalyzed by adding a non-nucleophillic base having a pKa greater than 7 to the solvent dissolved mixture.

Such a solvent-based reaction mixture can advantageously help keep the polymer chain in solution while the polymerization reaction is proceeding. The use of an anhydrous solvent can help to prevent or reduce undesired side reactions of the isocyanate functionalized monomer with water to form undesired side products such as urea. In particular, the water would react with the isocyanate making an unstable intermediate (carbamic acid) which would degrade into CO₂ and an amine. The amine would then react with a second isocyanate, forming the urea side product. The use of a solvent-based reaction mixture can also facilitate the controlled dilution of the first and second types of monomers and the non-nucleophillic base catalyst, which in turn allows the rate of the highly exothermic polymerization reaction to be controlled sufficiently so that the mixture does not heat up to a high temperature (e.g., 70° C. or higher). Such high temperatures can promote undesired side-reactions between the monomers of the same type which may become the dominant reaction resulting in lowered yields of the desired molecular weight of the thermoplastic thiourethane polymer.

Embodiments of the solvent include any aprotic organic molecule that does not contain functional groups that could react with the monomers or act as a catalyst of the polymerization reaction. Embodiments of the aprotic solvent are liquids at room temperature and preferably up to about 60 to 70° C. and the solvent can be provided or prepared as an anhydrous formulation (e.g., less than 0.2 weight percent water). In some embodiments, a polar aprotic solvent is preferred to facilitate more effective dissolution of the final polymer product. Non-limiting examples of the solvent include dimethylformamide (DMF), dimethylacetamide (DMA) and n-methyl-2-pyrrolidone (NMP); tetrahydrofuran; acetonitrile; dimethyl sulfoxide; nitromethane; and propylene carbonate or combinations thereof.

The use of a non-nucleophillic base is thought to advantageously provide a base that will catalyze the thiol-isocyanate polymerization reaction but will not react with the isocyanate functional groups and therefore can favorably provide stable reaction rates. Such non-nucleophillic bases are highly desirable catalysts to use because they will not react with the isocyanate groups of the second type monomer and thereby terminate the desired isocyanate-thiol polymerization reaction. This is in contrast to other types of nucleophillic base catalysts, such as primary amines or secondary amines, which will react with the isocyanate groups to form a urea, and therefore, are unsuitable for use as catalysts of the isocyanate-thiol polymerization reactions as disclosed herein.

In some embodiments, the polymerization reaction is catalyzed in an absence of a photo-initiated non-nucleophillic base catalyst. Photolatent bases are compounds which upon irradiation with light (e.g., UV or visible light), can decompose into components which include a non-nucleophillic base. Such photo-initiated catalysts are expensive and thereby could significantly increase the cost of a batch process production of the polymer. Such photo-initiated catalysts may not provide an advantage over using non-nucleophillic base catalyst that can simply be dissolved in the solvent and added to the solvent-based reaction mixture. Moreover, such photo-initiated non-nucleophillic base catalysts may not be effectively photo-initiated in batch solvent-based polymerization reactions where e.g., the solvent may absorb at the same wavelengths of light that would photo-initiate the decomposition of the photolatent base.

Embodiments of the non-nucleophillic base catalyst include any molecule having a tertiary amine group and a pKa greater than 7. Non-limiting examples of the non-nucleophillic base catalyst include triethylamine, 1,8-Diazabicyclo[5.4.0]undec-7-ene, 1,5-Diazabicyclo[4.3.0]non-5-ene, Tributylamine, 4-(Dimethylamino)pyridine, 1,4-Diazabicyclo[2.2.2]octane, 1,1,3,3-Tetramethylguanidine, or combinations thereof.

In some embodiments, the amount of the non-nucleophillic base catalyst added to the solvent-based mixture can be a value in a range from about 0.005 wt % to 5 wt % relative to the total weight of the first type of monomers plus the second type of monomers, and in some embodiments, a value in a range from about 0.1 to 1 wt %. In some embodiments, high amounts of nucleophillic base catalyst e.g., 1 wt % or higher, may cause the polymerization reaction to proceed so fast as to result in the generation of heat and an undesirable elevation in the temperature of the mixture. In some embodiments low amounts of non-nucleophillic base catalyst e.g., less than about 0.1 wt % or less than about 0.01 wt % in the mixture may help to mitigate such effects.

One embodiment of the disclosure is a thermoplastic thiourethane polymer. The thermoplastic thiourethane polymer comprises a sequential chain of a first type of monomer covalently bonded to a second type of monomer via thiourethane linkages. Each of the first type of monomer includes two or more thiol functional groups and each of the second type of monomer includes two or more isocyanate functional groups. The first and second types of monomers are polymerized together in an anhydrous solvent-based anionic step-growth polymerization reaction that is catalyzed by a non-nucleophillic base having a pKa greater than 7.

As disclosed herein the selection of the types of first and second types of monomer allows the thermal and mechanical properties of the thermoplastic thiourethane polymer to be adjusted to facilitate FFF printing and provide printed polymer products that we believe can be directly used for high-performance industrial applications requiring particular characteristics of e.g., semicrystallinity and/or toughness and/or other thermal or physical properties.

In some embodiments of the thermoplastic thiourethane polymer have a glass transition temperature (T_{g}) in a range from about −50° C. to 150° C. For some embodiments, the rigidity of thermoplastic thiourethane polymer is related to T_{g} such that the higher the T_{g}, the greater to rigidity. The glass transition temperature of the polymer can be shifted by the selection of different combinations of types of first and second monomer to thereby provide different thermoplastic thiourethane polymers of different rigidities.

For instance, to provide a high rigidity thermoplastic thiourethane polymer, e.g., corresponding to a T_{g} in the high end of this range, e.g., 100 to 150° C., highly rigid first and second types of monomers can be selected. Conversely to provide a low rigidity thermoplastic thiourethane polymer, e.g., corresponding to T_{g} in the low end of this range, e.g., −50 to 0° C. both of the first and second types of monomers can be selected to have low rigidity.

For example, embodiments the first type of monomer with a chain that includes one or more aromatic groups will tend be more rigid than a chain having aliphatic groups only. And short aliphatic chain length will tend to have a higher rigidity than the analogous monomer with a longer chain length. For example, embodiments of the second type monomers tending to range from highest to lowest rigidity can have chains that include one or more aromatic, caged aliphatic, cyclic aliphatic and linear aliphatic groups, respectively.

For instance, to provide a thermoplastic thiourethane polymer that can be used as a filament in a number of commercially available FFF printers, the polymer should have a melting temperature (Tₘ) of about 300° C. or less and in some embodiments, a melting temperature in a range from about 50 to 250° C.

For instance, to provide a polymer having a Tₘ in the low end of this temperature range (e.g., 100° C. or lower), some embodiments of the first and second monomer preferably have non-aromatic chains and which tend to form amorphous non-crystalline thermoplastic thiourethane polymers. For instance, to provide a polymer having a Tₘ in a high end of this temperature range (e.g., 200° C. or higher) some embodiments of the first and second monomer preferably have linear chains (e.g., to facilitate a high packing density) and a high number of thiol and isocyanate functional groups per monomer, respectively (e.g., three, four or more functional groups).

For instance some embodiments of the thermoplastic thiourethane polymers are semicrystalline with a crystalline value in a range from about 20 and 60 percent crystallinity. Some such embodiments can be synthesized using the first type of monomer have chains of linear aliphatic thiols and using the second type of monomer using chains which are able to pack efficiently. In some embodiments it is desirable to avoid the polymer being too crystalline and thus brittle, e.g., by adding small percentage (e.g., about 1 to 5 percent) a bulky thiol or isocyanate monomers, or, by adding an isomeric mixture of the monomers to mitigate efficient crystal packing.

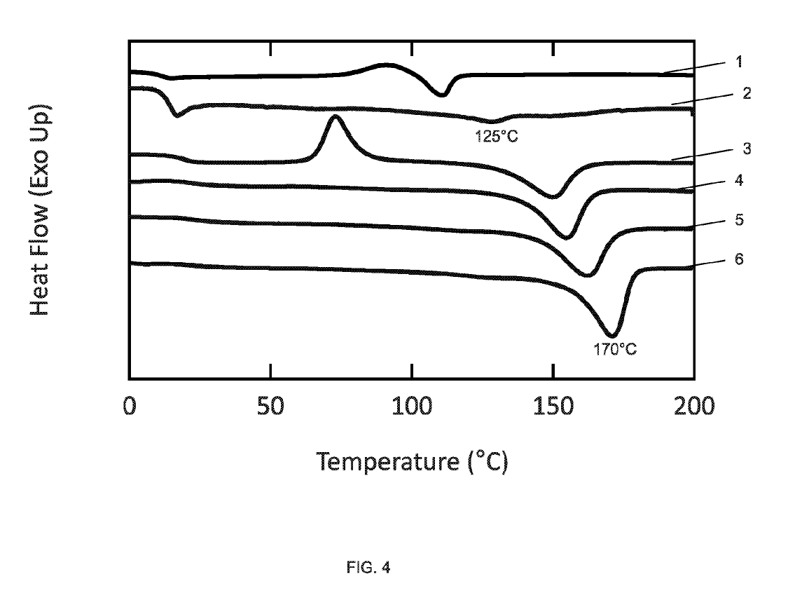

For instance, as further illustrated in the experimental section to follow (see e.g., FIG. 4), a thermoplastic thiourethane polymer having a Tₘ equal to about 125° C. can be synthesized using a first type of monomer that is a combination of 2,2′-(ethylenedioxy)diethanethiol (EDDT) and 1,10-decanedithiol (DDT) (mole fraction 80:20 EDDT:DDT) and a second type of monomer that is Hexamethylene diisocyanate (HDI) (mole fraction 100 EDDT+HDT: 100 HDI). A different higher rigidity thermoplastic thiourethane polymer having a Tₘ equal to about 170° C. can be synthesized using a first type of monomer that is a combination of 2,2′-(ethylenedioxy)diethanethiol (EDDT) and 1,10-decanedithiol (DDT) (mole fraction 20:80 EDDT:DDT) and a second type of monomer that is Hexamethylene diisocyanate (HDI) (mole fraction 100 EDDT+HDT:100 HDI).

Some embodiments of the thermoplastic thiourethane polymer have a toughness value that equals about 120 MJ/m³ or less and in some embodiments a value in a range from about 5 to 120 MJ/m³. The term toughness as used herein refers to the integrated area of a stress strain curve for a standard dog bone polymer sample as expressed in units of MJ/m³. An embodiment of the thermoplastic thiourethane polymer is defined to be tough if its toughness, equals about 10 MJ/m³ or higher, and, is defined to be ultra-tough if the toughness equals about 50 MJ/m³ or higher (e.g., 50 to 120 MJ/m³).

In some embodiments, the degree of toughness of the polymer is related to the crystallinity of the polymer such that the higher the crystallinity the higher the toughness. One skilled in the pertinent art would understand how to determine the percentage of crystallinity present in a polymer from x-ray scattering data or differential scanning calorimetry measurements collected from the polymer.

For instance, to synthesize a thermoplastic thiourethane polymer that is not tough (e.g., a toughness value of less than about 10 MJ/m³) in some embodiments, the first and second types of monomers can be selected to provide a non-crystalline amorphous thermoplastic thiourethane polymer. For example, monomers of the first and second types that have a low packing tendency, such as monomers with a chain that includes caged aliphatic groups, may be preferred. Additionally or alternatively, it may be preferable to select a mixture of monomers that include different compounds, with different molecular structures and/or formulas that do not pack well together, to all serve as the first type of monomers, and/or, to all serve as the second type of monomers. This later approach can be advantageous to use for embodiments where it desirable to reduce the crystallinity of a high melting temperature thermoplastic thiourethane polymer without substantially altering the melting temperature.

For instance, to synthesize a thermoplastic thiourethane polymer that is tough or ultra tough the first and second types of monomers can be selected to provide a semi-crystalline thermoplastic thiourethane polymer (e.g., crystallite structures among non-crystalline amorphous structure in the polymer). For example, monomers of the first and second types that have a high packing tendency, such as monomers with a chain that includes linear aliphatic groups, may be preferred.

Some embodiments of the thermoplastic thiourethane polymer have a rubbery modulus in a range from about 1 MPa to 2000 MPa. For instance, to produce a soft thermoplastic thiourethane polymer with a rubbery modulus in the low end of this range, the first and second types of monomers can be selected to provide a polymer having T_{g} in the low end of the T_{g} range discussed herein, and hence low rigidity, and, also have no or low crystallinity. Conversely, to produce a hard thermoplastic thiourethane polymer with a rubbery modulus in the high end of this range, as discussed elsewhere herein, the first and second types of monomers can be selected to provide a polymer having T_{g} in the high end of the T_{g} range discussed herein, and hence high rigidity, and, also have a higher degree of crystallinity.

The degree of crystallinity of the thermoplastic thiourethane polymer can be also be adjusted by controlling the degree of branching between growing chains of thiourethane polymers during the polymerization reaction. The degree of crystallinity can be increased by increasing the proportions of monomers of the first type and/or monomers of the second type having di-functional thiol and isocyanate groups, respectively. The presence of such di-functionalized monomers in the mixture is thought to facilitate the growth and elongation of linear non-branched segments of the polymer chain during polymerization. The degree of crystallinity can be decreased by increasing the proportions of monomers of the first type and/or monomers of the second type with tri-functional or higher thiol and isocyanate groups, respectively. The degree of crystallinity can be increased or decreased by using di-functional monomers with backbone structures that will tend to crystallize more or less favorably, respectively. The presence of such tri- or higher functionalized monomers is thought to facilitate the branching between segments of the growing polymer chain during polymerization which, in turn, tends to decrease the number or length of linear non-branched segments in the polymer.

It is desirable for some embodiments of the thiourethane polymers to have a crystallinity in a certain range to provide the requisite toughness for specific applications, e.g., for use in FFF printing applications. For instance, in some embodiments, if the proportion of such tri- or higher functionalized monomers is too high, then the resulting thiourethane polymers can have a non-crystalline amphorous structure that is not tough. In other embodiments, if the proportion of such tri- or higher functionalized monomers is too low or zero then the resulting thiourethane polymers can have a fully or near fully crystalline structure, resulting in a very brittle structure that is also not tough. For instance, in some embodiments, it is preferable for the thiourethane polymer to have a percentage crystallinity value that is in a range from about 5 percent to about 90 percent, and in some embodiments, from about 20 to 60 percent. In some embodiments, a value in a range from about 20 percent to about 40 percent may confer the polymer with a high or ultra toughness which may be desirable for certain FFF printing applications. In some embodiments, a value in a range from about 40 percent to about 60 percent may confer the polymer with a high dielectric constant which may be desirable for FFF printing certain electronics components. In some embodiments the percentage crystallinity value of the thiourethane polymer can be in such ranges at room temperature (20° C.) while in some embodiments such ranges of the percentage crystallinity of the polymer can be in such ranges at physiologic temperature (e.g., about 37° C.) which may be desirable for certain biological applications (e.g., FFF printed implantable probes).

As noted above in some embodiments, the mixture of monomers includes a combination of two different compounds of the first type of monomer having two or more thiol functional groups: a di-thiol functionalized monomer and a tri-thiol or higher functionalized monomer. In some embodiments, only one type of di-thiol functionalized monomer compound is used and only one type of tri-thiol or higher functionalized monomer is used in the mixture. In other embodiments, to facilitate further adjustment of the physical properties of the polymer more than one type of di-thiol functionalized monomer compound and/or more than type of tri-thiol or higher functionalized monomer may be used in the solvent-dissolved mixture.

In some embodiments, it is thought that the crystallinity of the polymer can be increased when the di-thiol functionalized monomer is a straight-chain aliphatic compound having a molecular weight in a range from about 100 to 300 gm/mol. Such monomers may also have advantageous properties for FFF printing application such as low melt viscosity. Non-limiting examples of such di-thiol functionalized monomers include EDT, PDT, HDT or DDT. In some such embodiments, the straight-chain is a hydrocarbon-only straight chain.

In some embodiments it is thought that crystallinity can be increased in the polymer when the two thiol functional groups of the di-thiol functionalized monomer are located at either end of the chain. For example, in some embodiments, the di-thiol functionalized monomer may be an alkane having the chemical formula HS—(CH₂)ₙ—SH where n is a number in the range of 2 to 10. Additionally, in some such embodiments, the use of such short chain di-thiol functionalized monomers were discovered to facilitate the synthesis of polythiourethanes having a high melt temperatures (e.g., in some embodiment greater than 100° C. and in other embodiments greater than 150° C.). While not limiting the scope of the disclosure by theoretical considerations, it is thought such shorter chain length di-thiol functionalized monomers, particularly when used with similarly shorter chain length di-isocyanate functionalized monomers, promote the formation linear chains in the polymer which in turn tends to increase the amount of crystallinity in the polymer. It is thought that this is most likely due to the increase in the number of thio-isocyanate groups in the backbone, increasing both rigidity and hydrogen bonding between the chains and raising the melt temperature.

In some embodiments, the straight-chain di-thiol functionalized monomer can include one or more oxygen and/or sulphur atoms in the chain as alkyl ether and/or thio-ether groups, respectively. Non-limiting examples include TDET, EDDT or BD1. It is thought that the inclusion of oxygen or sulphur in the polymer backbone due to presence of such alkyl ether and/or thio-ether containing di-thiol functionalized monomers may disrupt orderly packing of the linear segments of the polymer. This in turn may reduce the thermal energy necessary to melt the crystallites and/or discourage recrystallization. As such the inclusion of such ether and/or thioether groups in the chain of the di-thiol functionalized monomers may be used to adjust the melting point and recrystallization of the polythiourethane polymers synthesized as described herein. For instance, the replacement of some or all of the above described straight-chain aliphatic di-thiol functionalized monomers with alkyl ether and/or alkyl sulfide containing analogs may reduce the polymer's melt temperature and/or enhance crystallization hysteresis.

In still other embodiments, the di-thiol functionalized monomer may include branched-chained or cyclic compounds (e.g., TCDDT) and/or aromatic compounds having a molecular weight in a range from about 100 to 300 gm/mol. In other embodiments longer chain length compounds may be used, e.g., a molecular weight in a range from about 300 to 1000 gm/mol. In yet other embodiments one or both of the thiol functional groups are not located at the ends of the straight chain but rather are located on internal atoms of the chain.

In some embodiments, the tri-thiol or higher functionalized monomer is a tri-thiol functionalized monomer. Non-limiting examples include TMICN or TMTMP. In some embodiments, the tri-thiol or higher functionalized monomer is a tetra-thiol functionalized monomer. A non-limiting example includes PETMP. Still other embodiments may include penta- hexa- or hepta-thiol functionalized monomers. It is thought that crosslinking may be promoted by increasing the number of thiol functions per monomer molecule. In some such embodiments, it can be advantageous, so as to provide a low viscosity and miscibility with other components of the solvent-dissolved mixture, for the tri-thiol or higher functionalized monomer to have a molecular weight of 300 gm/mol or less, although in other embodiments higher molecular weight monomers may be used.

In some embodiments, for example, the mixture of monomers can include a combination of two different compounds of the second type of monomer having two or more isocyanate-functional groups: a di-isocyanate functionalized monomer and a tri-isocyanate or higher functionalized monomer. In some embodiments, only one type of di-isocyanate functionalized monomer compound is used, and only one type of tri- di-isocyanate or higher functionalized monomer is used, in the mixture. In other embodiments, to facilitate further adjustment of the physical properties of the polymer, more than one type of di-isocyanate functionalized monomer compound and/or more than type of tri-isocyanate or higher functionalized monomer can be used in the mixture.

As noted above, it is thought that the degree crystallinity of some embodiments of the polymer can be promoted when the di-isocyanate functionalized monomer is a straight-chain aliphatic compound having a molecular weight in a range from about 100 to 300 gm/mol. Additionally, for the same reasons expressed above, the low viscosity and miscibility properties of such compounds can be advantageous. Similarly, for some embodiments, it is thought that crystallinity can be promoted in the polymer when the two isocyanate functional groups of the di-isocyanate functionalized monomer are located at either end of the chain. In some such embodiments the straight-chain is a carbon-only straight chain. For example, in some embodiments, the di-isocyanate functionalized monomer may be an alkane having the chemical formula OCN—(CH₂)ₙ—NCO where n is a number in the range of 2 to 10. A non-limiting example of such a di-isocyanate functionalized monomer is HDI. For the same reasons expressed above, such shorter chain lengths of di-isocyanate functionalized monomers, particularly when used with similarly shorter chain length di-thiol functionalized monomers, is thought promote the formation linear chains in the polymer which in turn tends to increase the amount of crystallinity in the polymer.

In other embodiments, however, the straight-chain di-isocyanate functionalized monomer can include one or more oxygen and/or sulphur atoms in the chain as alkyl ether and/or thio-ether groups, respectively. In still other embodiments, the di-isocyanate functionalized monomer may include branched-chained or cyclic compounds (e.g., IDI or HDI-T) and/or aromatic compounds (e.g., XDI or TDI) and have a molecular weight in a range from about 100 to 300 gm/mol. In other embodiments longer chain length compounds may be used, e.g., a molecular weight in a range from about 300 to 1000 gm/mol. In yet other embodiments, one or both of the isocyanate functional groups are not located at the ends of the straight chain but rather are located on internal atoms of the chain.

In some embodiments, the tri-isocyanate or higher functionalized monomer is a tri-isocyanate functionalized monomer or a tetra-isocyanate functionalized monomer. Still other embodiments include penta- hexa- or hepta-isocyanate functionalized monomers. It is thought that crosslinking may be promoted by increasing the number of isocyanate functions per monomer molecule. In some such embodiments it can be advantageous, so as to provide a low viscosity and miscibility with other components of the solvent dissolved mixture, for the tri-isocyanate or higher functionalized monomer to have a molecular weight of 300 gm/mol or less, although in other embodiments higher molecular weight monomers may be used.

In some embodiments, when the solvent dissolved mixture includes the first type of monomer with both the di-thiol and tri-thiol or higher functionalized monomers, then the mixture may only include the second type of monomer having the di-isocyanate functionalized monomer. Conversely, in some embodiments, when the mixture includes the second type of monomer with both the di-isocyanate and tri-isocyanate or higher functionalized monomers then the mixture may only include the first type of monomer having the di-thiol functionalized monomer. However, in still other embodiments, the mixture could include combinations of di-thiol functionalized monomers, tri-thiol or higher functionalized monomers, di-isocyanate functionalized monomers and tri-isocyanate or higher functionalized monomers.

Non-limiting examples of the first type of monomer having two or more thiol functional groups include: Trimethylolpropane tris(3-mercaptopropionate); Trimethylolpropane tris(2-mercaptoacetate); Pentaerythritol tetrakis(2-mercaptoacetate); Pentaerythritol tetrakis(3-mercaptopropionate); 2,2′-(Ethylenedioxy)diethanethiol; 1,3-Propanedithiol; 1,2-Ethanedithiol; 1,4-butanedithiol; 1,5-pentanedithiol; 1,6-hexanedithiol; 1,9-nonanedithiol; xylene dithiol; Thiobis(benzenethiol); 1,4-Butanediol bis(thioglycolate); 1,4-bis(3-mercaptobutylyloxy)butane; Tris[2-(3-mercaptopropionyloxy)ethyl] isocyanurate; 3,4-ethylenedioxythiophene; 1,10-Decanedithiol; Tricyclo[5.2.1.02,6]decanedithiol; and Benzene-1,2-dithiol; Trithiocyanuric acid.

Non-limiting examples of the second type of monomer having two or more isocyanate functional groups include: Hexamethylene diisocyanate; isophorone diisocyanate; diisocyanatobutane; diisocyanatooctane; 1,3,5-Tris(6-isocyanatohexyl)-1,3,5-triazinane-2,4,6-trione; phenylene diisocyanate; xylylene diisocyanate; tolyene diisocyanate; cyclohexylene diisocyanate; and toluene diisocyanate; methylenebis(phenyl isocyanate).

As disclosed herein range of compounds that the first and second type of monomer may be composed of, and their relative amounts used, provides a variety of approaches for adjusting crystallinity and hence toughness or other physical properties of the thiourethane polymers synthesized as described herein.

As further non-limiting examples, in some embodiments, the amount of di-thiol functionalized monomers added to the solvent-dissolved mixture can be adjusted such that the mole percentage (mol %) of thiols contributed equals a percentage value in a range from 25 to 100 percent and in some embodiments 90 to 100 percent, and, the amount of tri-thiol or higher functionalized monomers added to the mixture is adjusted such that the mol % of thiols contributed equals a percentage value in a range from 75 to 0 percent, and in some embodiments 10 to 0 percent. In some such embodiments, the amount of the second type of monomer added to allow for a stoichiometric reaction to occur corresponds to 100 mol % from a di-isocyanate functionalized monomer. However, in other embodiments, it can be advantageous to provide off-stoichiometric ratios of total thiol functional groups to isocyanate functional groups, e.g., to give excess thiol or excess isocyanate functional groups. As another non-limiting example, in some embodiments, the amount of di-isocyanate functionalized monomers added to the mixture is adjusted such that the mol % of di-isocyanates contributed equals a percentage value in a range from 25 to 100 and in some embodiments, 90 to 100 percent and the amount of tri-isocyanate or higher functionalized monomers added to the mixture is adjusted such that the mol % of isocyanates contributed equals a percentage value in a range from 75 to 0 percent and in some embodiments 10 to 0 percent. In some such embodiments, the amount of the first type of monomer added to allow for a stoichiometric reaction to occur corresponds to 100 mol % from a di-thiol functionalized monomer. However, in other embodiments, it can be advantageous to provide off-stoichiometric ratios of total thiol functional groups to isocyanate functional groups, e.g., to give excess thiol or excess isocyanate functional groups.

In some embodiments, to facilitates the synthesis of a thermoplastic thiourethane polymer, the di-thiol functionalized monomers added to the mixture are such that the mol % of thiols contributed from di-thiol functionalized monomer equals about 100 percent, and, the amount of di-isocyanate functionalized monomers added to the mixture is such that the mol % of isocyanates contributed from di-isocyanates functionalized monomer equals about 100 percent.

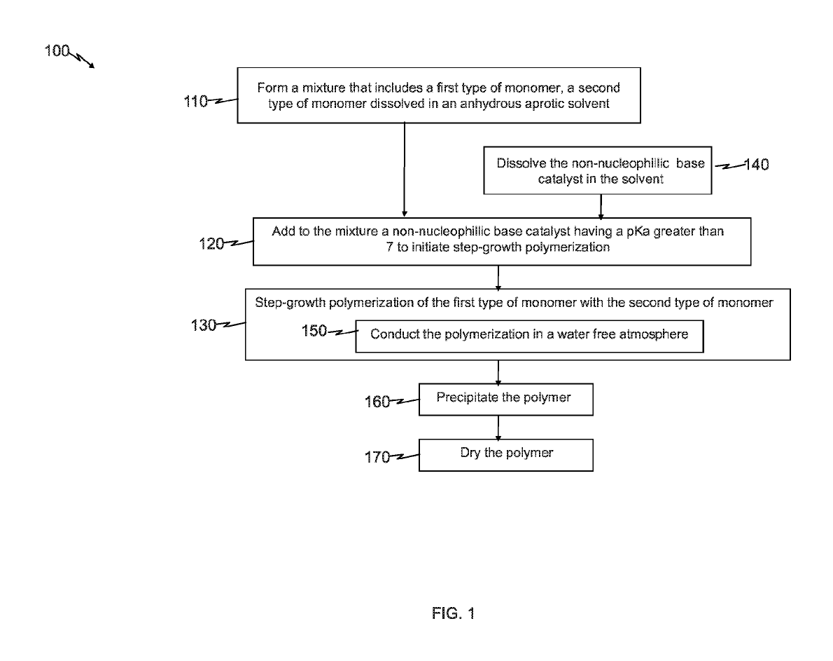

Another embodiment of the disclosure is a method of synthesizing a thermoplastic thiourethane polymer. FIG. 1 illustrates by flow diagram, selected aspects of an example method 100 of synthesizing thermoplastic thiourethane polymers according to the principles of the present disclosure. The example method 100 comprises a step 110 of forming a mixture that includes a first type of monomer, a second type of monomer dissolved in an anhydrous aprotic solvent. The first type of monomer includes two or more thiol functional groups and the second type of monomer includes two or more isocyanate functional groups. The method further comprises a step 120 of adding to the mixture a non-nucleophillic base having a pKa greater than 7 to thereby catalyze an anionic step-growth polymerization reaction to form a sequential chain of the first type of monomer covalently bonded to the second type of monomer via thiourethane linkages to thereby initiate step-growth polymerization (step 130) of the first type of monomer with the second type of monomers.

In some embodiments, the non-nucleophillic base can be pre-dissolved in the solvent (step 140) prior to being added to the mixture. In some embodiments, the step-growth polymerization reaction (step 130) is carried out in a water free atmosphere (step 150) e.g., by passing nitrogen gas over vessel containing the reaction mixture. In some embodiments, at the end of the polymerization reaction (step 130) the polymer in the solvent is precipitated (step 160) by adding pouring the polymer-containing solvent into water, e.g., deionized or distilled water. In some embodiments, the precipitated polymer can then be dried (step 170), e.g., to remove the solvent and water by placing the polymer in a vacuum container and/or heating the polymer.

Any embodiments of the method 100 can include any of the variations in the compositions and amounts of the first and second types of monomers and non-nucleophillic base catalysts and the physical conditions for polymerization as disclosed herein.

In some embodiments, to avoid or reduce other chemical reactions from occurring, it is preferable for the first and second types of monomers to not have any other types of functional groups that may react, either before or during photo-initiation, with the thiol functional and isocyanate functional groups of the first and second types of monomers. In some embodiments for instance, the first type of monomer does not have-ene or isocyanate functional groups and the second type of monomer does not have-ene or thiol functional groups. In some embodiments for instance, the first type of monomer only has thiol functional groups and the second type of monomer only has isocyanate functional groups.

Alternatively in some embodiments, excess thiol or isocyanate functionalized monomers can be added at the end of the polymerization reaction to form a telechelic polymer with reactive thiol or isocyanate moieties appended to the ends of the polymer chain which can be used to affix polymerizabile functionalities (such as enes, epoxies, acrylates, maleimides, furans, etc) for post polymerization curing.

In any embodiments of the method 100 a third type of monomer may be added to the mixture where the each of the third type of monomer has a single thiol functional group or a single isocyanate functional group. Such mono-functionalized monomers may be used to facilitate chain capping and branched networks in the thiourethane polymer and/or limit the molecular weight of the thiourethane polymer. For instance, in some embodiments, the mole ratio of the single thiol functional group or a single isocyanate functional group, provided by the third type of monomer, to the two or more functional groups, provided by the first or the second type of monomer, is equal to or greater than about 1:2 or less. For instance, in some embodiments, the average molecular weight of the thermoplastic polymer has a value in a range from about 10,000 to 1,000,000.

Non-limiting example embodiments of the third type of monomer having a single thiol functional group include: 1-butanethiol; 1-hexanethiol; 1-heptanethiol; 1-octanethiol; 1-nonanethiol; 1-decanethiol; and 1-octadecanethiol. Non-limiting example embodiments of the third type of monomer having a single isocyanate functional group include: propyl isocyanate; 1-pentyl isocyanate; hexyl isocyanate; octyl isocyanate; nonyl isocyanate; sec-butyl isocyanate; 2-ethylhexyl isocyanate; cyclopentyl isocyanate; and 1-isocyanato-3-methylbutane.

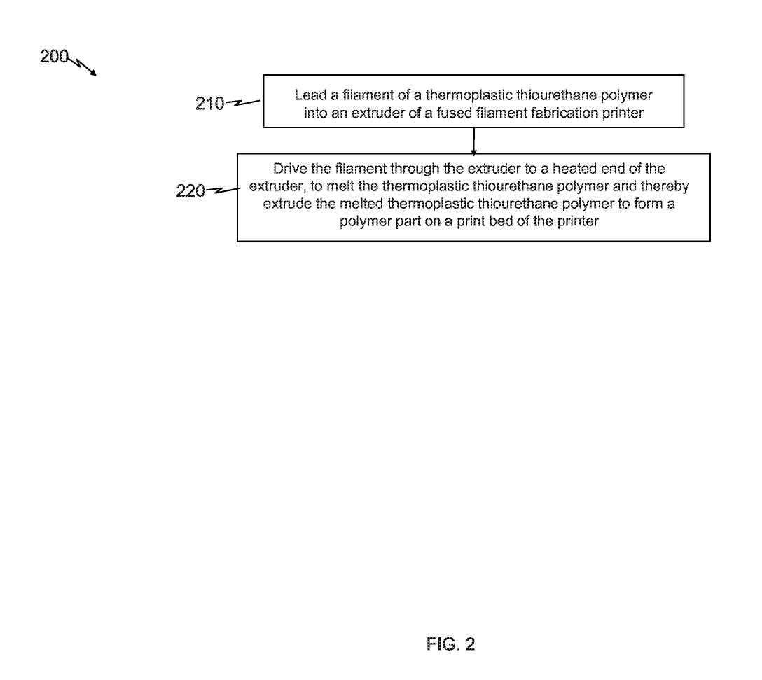

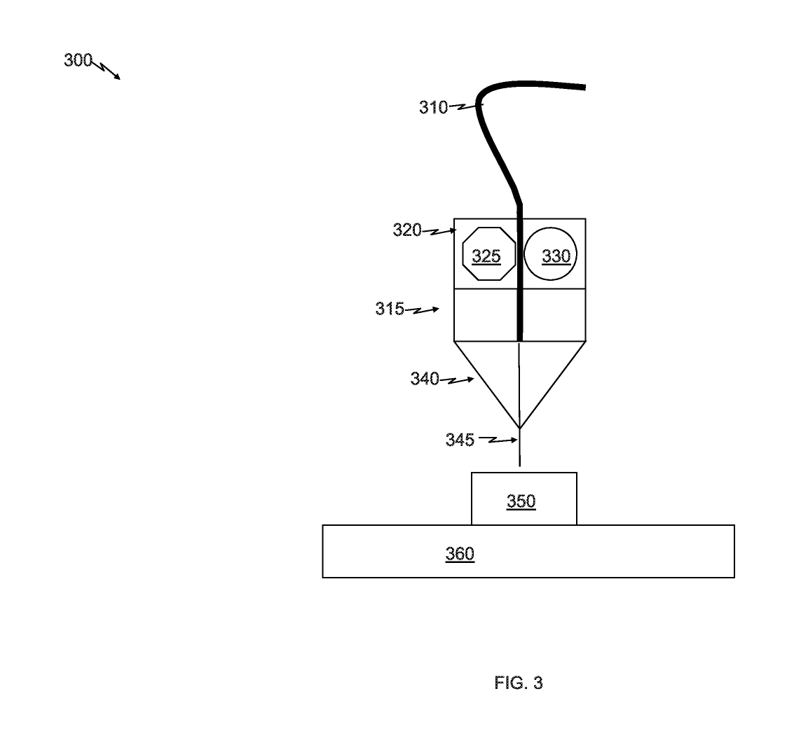

Still another embodiment of the disclosure is a method of fused filament fabrication printing. FIG. 2 illustrates by flow diagram, selected aspects of an example fused filament fabrication printing method 200 of manufacturing a polymer part that includes the thermoplastic thiourethane polymers, according to the principles of the present disclosure. FIG. 3 presents selected aspects of a fused filament fabrication printer 300 using filaments 310 composed of the thermoplastic thiourethane polymer synthesized according to the principles of the present disclosure.

With continuing reference to FIGS. 2 and 3 throughout, the example method 200 comprises a step 210 of leading a filament 310 of a thermoplastic thiourethane polymer into an extruder 320 of the fused filament fabrication printer 300.

One skilled in the pertinent arts would be familiar with procedures to form the thermoplastic thiourethane polymer disclosed herein into filaments suitable for FFF printing.

The example method 200 also comprises a step 220 of driving the filament 310 through the extruder 315 (e.g., via a torque and pinch module using a grooved bolt 325 and a push wheel 330) to a heated end module 340 of the extruder, to melt the thermoplastic thiourethane polymer (e.g., in some embodiments at a temperature of about 300° C. or less or in some embodiments 250° C. or less) and thereby extrude the melted thermoplastic thiourethane polymer 345 to form a polymer part 350 on a print bed 360 of the printer 300.

To facilitate understanding of various features of the disclosure, the structures and acronyms of some of the example monomers and base catalysts referred to in the text and figures are presented below:

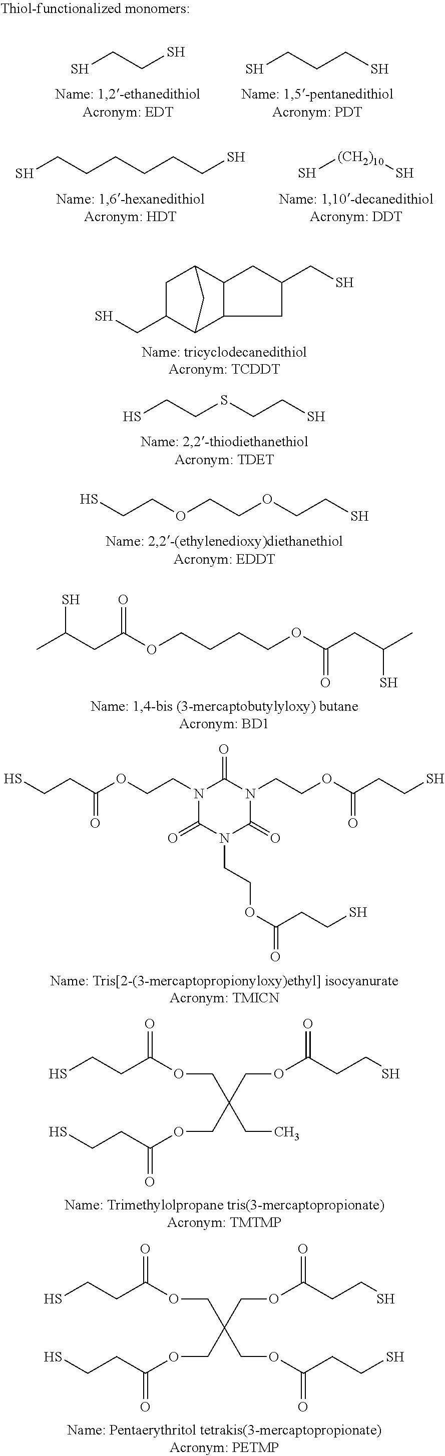

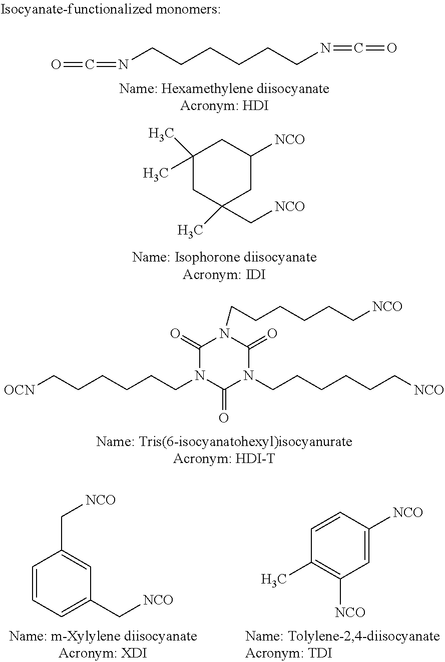

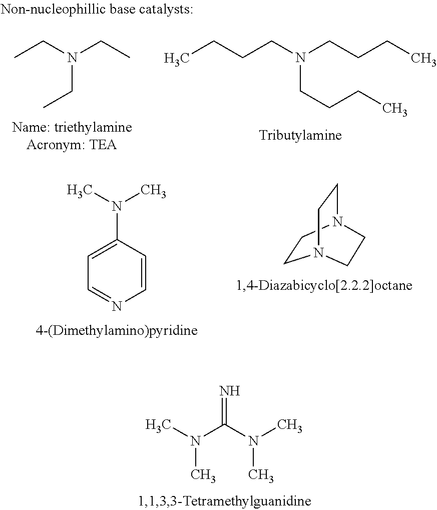

To further illustrate various features of the disclosure, the synthesis of non-limiting example thermoplastic thiourethane polymers and some of their physical and mechanical properties are presented below.

Example thermoplastic thiourethane polymer synthesis.

In one series of experiments, the polymer was synthesized using a reaction vessel comprising a two liter round bottom flask fitted with condenser, addition funnel, over-head stirrer, vacuum line, nitrogen inlet.

Table 1 summarizes the mole fractions of the first and second types of monomers used to synthesize different thermoplastic thiourethane polymer compositions.

TABLE 1
Synthesized compositions by mole fraction

| Composition | | | | |
|---|---|---|---|---|
| Number | EDDT | DDT | HDI | IDI |
| 1 | 100 | 0 | 100 | 0 |
| 2 | 80 | 20 | 100 | 0 |
| 3 | 60 | 40 | 100 | 0 |
| 4 | 50 | 50 | 100 | 0 |
| 5 | 40 | 60 | 100 | 0 |
| 6 | 20 | 80 | 100 | 0 |
| 7 | 100 | 0 | 0 | 100 |

The anionic step-growth polymerization reaction scheme is summarized below for composition 1:

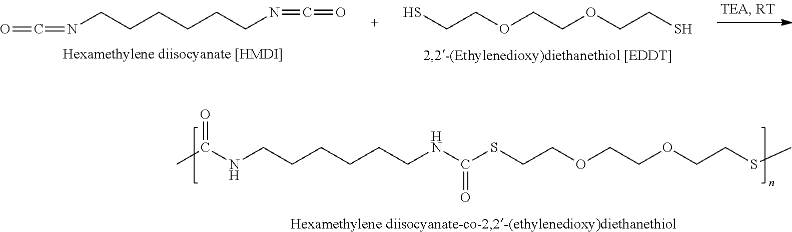

To produce thermoplastic thiourethane polymer composition 1, first and second types of monomers, EDDT (227.88 g), HMDI (210.24 g), respectively, and the aprotic solvent, DMF (650 ml of anhydrous DMF) were added to the round bottom flask. The vacuum line was opened to purge off the gases inside the reaction vessel. The vacuum line was closed and then and the nitrogen inlet valve was slowly opened to fill the reaction vessel with N₂. The nitrogen line was kept open until the end of reaction while maintaining low N₂ flow. Next the over-head stirrer was started. The non-nucleophillic base catalyst, TEA, (0.316 g pre-dissolved in 100 ml of anhydrous DMF) was then transferred to the reaction vessel via the addition funnel over the course of 2 minutes to start the polymerization reaction. The reaction proceeded for 30 minutes. The polymer was then precipitated by pouring the solvent with the polymer dissolved therein into a deionized water bath. The precipitated polymer was then washed with excess amount of water and then dried in a vacuum oven at 70° C. for two day to remove all the solvents from the polymer. Yields of the polymer exceeded 430 g.

Additional thermoplastic thiourethane polymer compositions 2-7 were synthesized using the same procedures as described above with the exceptions that the first types of monomer included different mole fractions of EDDT and DDT (compositions 2-6), or, the second type of monomer used was IDI (composition 7).

FIG. 4 presents example differential scanning calorimetry heating ramps of thermoplastic thiourethane polymer compositions 1-6 synthesized as described herein and in the context of Table 1. As illustrated the melt temperature of the polymer compositions vary widely from about 125° to 170° C. dependent on the relative mole fractions of EDDT and DDT used in combination with HDI.

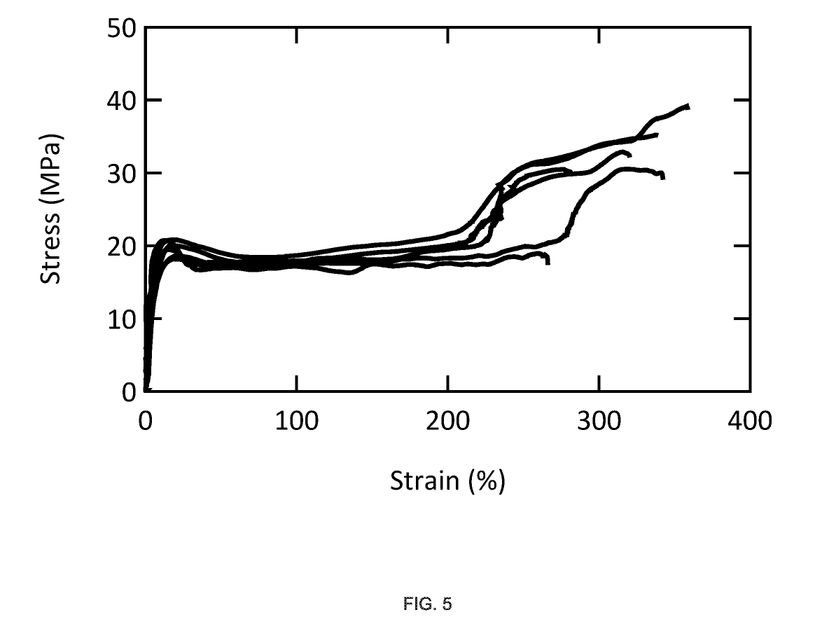

FIG. 5 presents example tensile stress versus strain behavior at 20° C. for the thermoplastic thiourethane polymer composition 1. Several samples of composition 1 were formed into filaments and then formed into standard dog bone samples via fused filament fabrication on a commercial 3D printer. The integrated area of these stress strain curves correspond to a toughness of about 120 MJ/m³.

Those skilled in the pertinent arts to which this application relates will appreciate that other and further additions, deletions, substitutions and modifications may be made to the described embodiments.

1. A thermoplastic thiourethane polymer comprising:
a sequential chain of a first type of monomer covalently bonded to a second type of monomer via thiourethane linkages, wherein:
the first type of monomer includes two or more thiol functional groups and the second type of monomer includes two or more isocyanate functional groups,
the first and second types of monomers are polymerized together in an anhydrous aprotic solvent-dissolved anionic step-growth polymerization reaction that is catalyzed by a non-nucleophillic base catalyst having a pKa greater than 7, and
the sequential chain includes the first type of monomer with a linear aliphatic group.

2. The polymer of claim 1, wherein the sequential chain has the first type of monomer with one or more aromatic groups.

3. The polymer of claim 1, wherein the sequential chain has the first type of monomer with the linear aliphatic group only.

4. The polymer of claim 1, wherein the sequential chain has the second type of monomer with one or more aromatic, caged aliphatic, or cyclic aliphatic groups.

5. The polymer of claim 1, wherein the sequential chain has the second type of monomer with a linear aliphatic group.

6. The polymer of claim 1, wherein the polymer has a toughness value of about 50 MJ/m³ or higher.

7. The polymer of claim 1, wherein the first type of monomer includes a di-thiol functionalized monomer and a tri-thiol or higher functionalized monomer, wherein a mole percent of the first type of monomer having di-thiol functionalized monomers is in a range of from 25 to 90 percent and a mole percent of the first type of monomer having tri-thiol or higher functionalized monomers is in a range of from 75 to 10 percent.

8. The polymer of claim 1, wherein the second type of monomer includes a di-isocyanate functionalized monomer and a tri-isocyanate or higher functionalized monomer, wherein a mole percent of the second type of monomer having di-isocyanate functionalized monomers is in a range of from 25 to 90 percent and a mole percent of the second type of monomer having tri-isocyanate or higher functionalized monomers is in a range of from 75 to 10 percent.

9. The polymer of claim 1, wherein the first type of monomer includes one or more of: Trimethylolpropane tris(3-mercaptopropionate); Trimethylolpropane tris(2-mercaptoacetate); Pentaerythritol tetrakis(2-mercaptoacetate); Pentaerythritol tetrakis(3-mercaptopropionate); 2,2′-(Ethylenedioxy)diethanethiol; 1,3-Propanedithiol; 1,2-Ethanedithiol; 1,4-butanedithiol; 1,5-pentanedithiol; 1,6-hexanedithiol; 1,9-nonanedithiol; xylene dithiol; Thiobis(benzenethiol); 1,4-Butanediol bis(thioglycolate); 1,4-bis(3-mercaptobutylyloxy)butane; Tris[2-(3-mercaptopropionyloxy)ethyl] isocyanurate; 3,4-ethylenedioxythiophene; 1,10-Decanedithiol; Tricyclo[5.2.1.02,6]decanedithiol; and Benzene-1,2-dithiol; Trithiocyanuric acid.

10. The polymer of claim 1, wherein the second type of monomer includes one or more of: Hexamethylene diisocyanate; isophorone diisocyanate; diisocyanatobutane; diisocyanatooctane; 1,3,5-Tris(6-isocyanatohexyl)-1,3,5-triazinane-2,4,6-trione; phenylene diisocyanate; xylylene diisocyanate; tolyene diisocyanate; cyclohexylene diisocyanate; and toluene diisocyanate; methylenebis(phenyl isocyanate).

11. The polymer of claim 1, wherein the sequential chain further includes a third type of monomer with a single thiol functional group or a single isocyanate functional group, wherein a mole ratio of the single thiol functional group or the single isocyanate functional group of the third type of monomer relative to the two or more thiol functional groups or the two or more isocyanate functional groups of the first type of monomer or the second type of monomer, respectively, equals about 1:2 or less.

12. The polymer of claim 11, wherein the third type of monomer includes one or more of: 1-butanethiol; 1-hexanethiol; 1-heptanethiol; 1-octanethiol; 1-nonanethiol; 1-decanethiol; and 1-octadecanethiol, propyl isocyanate; 1-pentyl isocyanate; hexyl isocyanate; octyl isocyanate; nonyl isocyanate; sec-butyl isocyanate; 2-ethylhexyl isocyanate; cyclopentyl isocyanate; and 1-isocyanato-3-methylbutane.

13. A method of synthesizing a thermoplastic thiourethane polymer, comprising:
forming a mixture that includes a first type of monomer and a second type of monomer dissolved in an anhydrous aprotic solvent; and
adding to the mixture a non-nucleophillic base catalyst having a pKa greater than 7 to thereby initiate an anionic step-growth polymerization reaction to form a sequential chain of the first type of monomer covalently bonded to the second type of monomer via thiourethane linkages, wherein, the first type of monomer includes two or more thiol functional groups and the second type of monomer includes two or more isocyanate functional groups, and the sequential chain includes the first type of monomer with a linear aliphatic group.

14. The method of claim 13, wherein the anhydrous aprotic solvent is a liquid from room temperature to about 70° C. and contains less than 0.2 weight percent water.

15. The method of claim 13, wherein the anhydrous aprotic solvent is a polar aprotic solvent.

16. The method of claim 15, wherein the polar aprotic solvent includes dimethylformamide (DMF), dimethylacetamide (DMA) and n-methyl-2-pyrrolidone (NMP); tetrahydrofuran; acetonitrile; dimethyl sulfoxide; nitromethane; and propylene carbonate or combinations thereof.

17. The method of claim 12, wherein the anionic step-growth polymerization reaction that is catalyzed by a non-nucleophillic base catalyst is in an absence of a photo-initiated non-nucleophillic base catalyst.

18. The method of claim 17, wherein the non-nucleophillic base catalyst includes triethylamine, 1,8-Diazabicyclo[5.4.0]undec-7-ene, 1,5-Diazabicyclo[4.3.0]non-5-ene, Tributylamine, 4-(Dimethylamino)pyridine, 1,4-Diazabicyclo[2.2.2]octane, 1,1,3,3-Tetramethylguanidine, or combinations thereof.

19. The method of claim 17, wherein the non-nucleophillic base catalyst added to the solvent-based mixture is less than about 0.1 wt % relative to the total weight of the first type of monomers plus the second type of monomers.

20. A method of fused filament fabrication printing, comprising:
leading a filament of the thermoplastic thiourethane polymer of claim 1 into an extruder of a fused filament fabrication printer; and
driving the filament through the extruder to a heated end of the extruder, to melt the thermoplastic thiourethane polymer and thereby extrude the thermoplastic thiourethane polymer to form a polymer part on a print bed of the printer.
